(19) United States
(12) Patent Application Publication
(10) Pub. No.: US 2008/0234140 A1
(43) Pub. Date: Sep. 25, 2008

(54) Method and Device for Applying a Plurality of Microdroplets on a Substrate

(75) Inventor: Andreas Kuoni, Biel (CH)

Correspondence Address: PEARNE & GORDON LLP, 1801 EAST 9TH STREET, SUITE 1200, CLEVELAND, OH, 44114-3108, US

(73) Assignee: A. KUONI, BIEL/BIENNE, SWITZERLAND (CH)

(21) Appl. No.: 11/908,921

(22) PCT Filed: Mar. 17, 2005
(86) PCT No.: PCT/EP05/51255

§ 371 Date: Sep. 17, 2007

(51) Int. Cl. C40B 50/00; C40B 60/14; B23P 17/00

(52) U.S. Cl. 506/23; 506/40; 29/890.1

(57) ABSTRACT

The invention relates to a device for applying a plurality of microdroplets to a substrate (65) comprising a plate (50) provided with a plurality of bore holes (51) and a bottom (52) which is connected to said plate (50), and is provided with a plurality of channels (53). The device is characterized in that each bore (51) of the plate (50) is assigned to a single channel (53) of the bottom (52).

The invention also relates to a method for producing this device, the use of this device for applying a plurality of microdroplets to a substrate (65), as well as a method for applying a plurality of microdroplets to a substrate (65).

The present invention relates to a device and a method for applying a plurality of microdroplets on a substrate, and in particular such a device and such a method which make possible the simultaneous application of a plurality of microdroplets.

### STATE OF THE ART

Devices and methods of this kind are known, and generally serve the creation of so-called biochips in which a plurality of different analytes are applied on a substrate in order to detect different substances in an unknown sample.

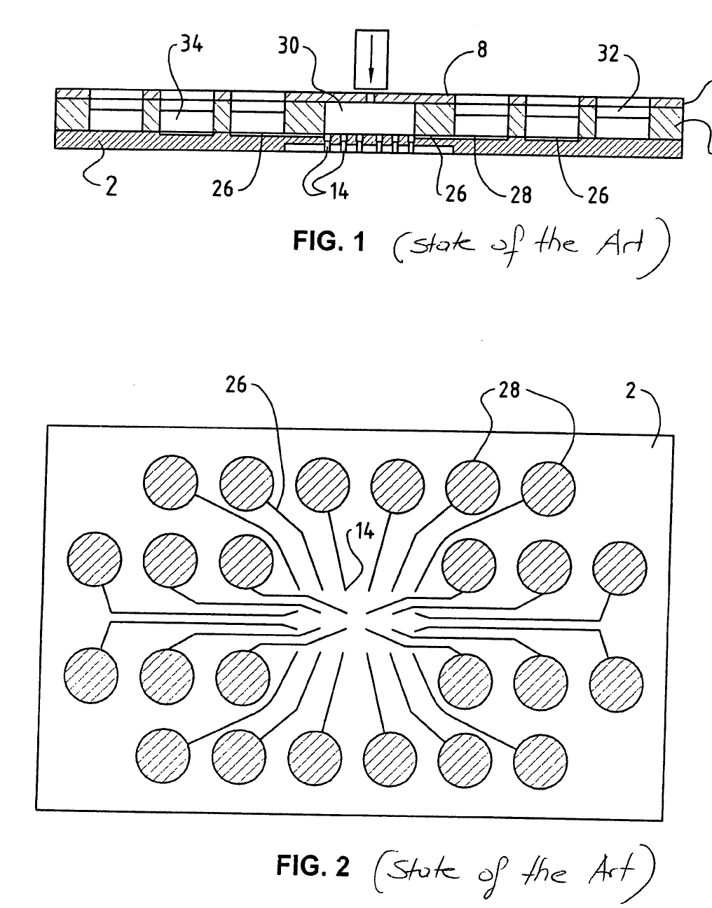

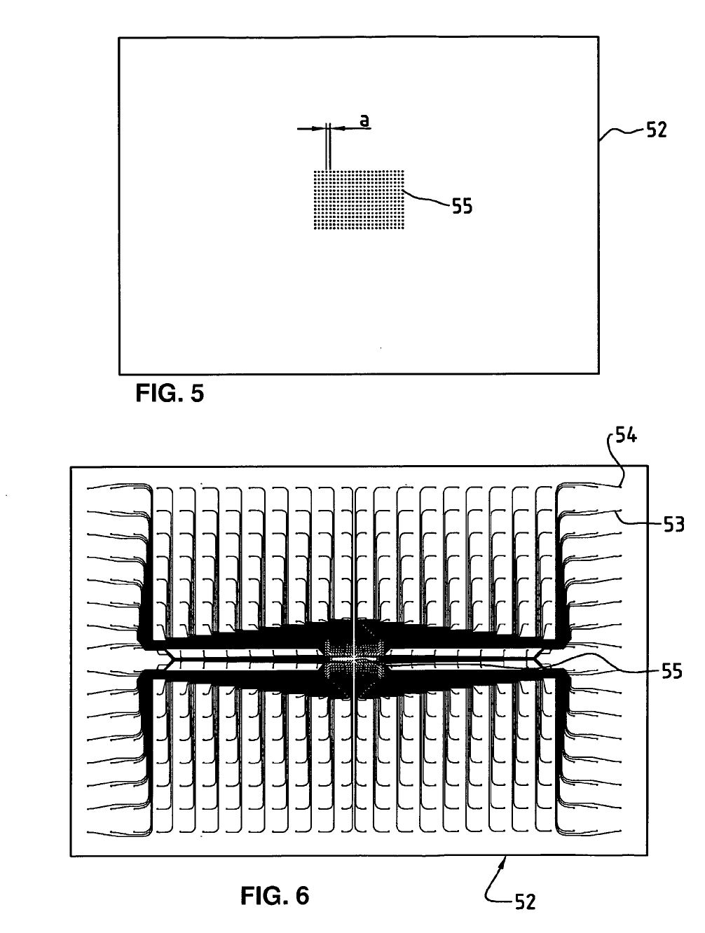

Thus, for example in FIG. 5 von WO 01/171669 <sic. 01/17669> (which corresponds to the attached FIG. 1) a device is shown which consists of a structured silicon substrate 2, a plate 4 put on the silicon substrate 2 as well as a layer 6 put on the plate 4 in which a displacement membrane 8 is formed.

The silicon substrate 2 has media lines 26, which connect the media reservoir 28 of the plate 4 to jets 14.

The plate 4 has a central recess or bore hole 30 which serves as a pressure chamber, and additional bore holes 32, which are each disposed via a media reservoir 28, and increase the capacity of this media reservoir 28.

By means of pressing upon the displacement membrane 8, a pressure is generated which impinges on the media 34 located in the jets 14, so that these media flow through the jets 14 and reach the lower surface of the silicon substrate 2.

A drawback of this device is, on the one hand, that a special plate must be made having a central bore hole 30 in addition to the bore holes 32 for the media reservoir. This central bore hole is assigned to all jets 14. This means that such a plate 4 must be specially manufactured for this device with great expense.

On the other hand, the number of media reservoirs 28 is small because these media reservoirs 28 are large (see FIG. 4 of WO 01/171669, <sic. 01/17669> which corresponds to the attached FIG. 2).

Furthermore the activation of the membrane 8 is not reliable, and since the pressure is not generated via the media reservoirs 28, but centrally via the jets 14, this pressure is not very efficient and therefore the media 34 cannot reach the lower surface of the silicon substrate 2 quickly.

Finally, there is always the risk that the media 34 get mixed in the central bore hole 30.

The object of the present invention is to design a device of the initially mentioned type in such a way that this device at least

definitely reduces a mixing of the fluids,

uses a simple plate,

is able to be produced inexpensively, and

makes possible an efficient, reliable and reproducible application of many fluids and of a large number of microdroplets of each fluid.

### DISCLOSURE OF INVENTION

According to the invention, this object is achieved through a device having the following features:

a plate having a plurality of bore holes, and

a bottom which is connected to the plate and has a plurality of channels,

each channel of the bottom having an inlet opening on a side facing the plate and an outlet opening on a side remote from the plate, and

the spacing between the centerlines of two adjacent outlet openings being smaller than the spacing between the centerlines of two adjacent inlet openings,

wherein each bore hole of the plate is assigned to a single channel.

All bore holes are preferably identical.

A further preferred embodiment of the invention consists in that the configuration of the outlet openings of the channels of the bottom corresponds to the configuration of bore holes of the plate.

A further preferred embodiment of the invention consists in that all outlet openings are substantially identical.

According to an embodiment, the outlet openings are disposed regularly about the centerline of the bottom.

According to another embodiment, the cross-sectional area of the outlet openings is smaller than the cross-sectional area of the inlet openings.

According to a further embodiment, the plate has dimensions of 10 to 15 cm×6 to 10 cm×0.3 to 3 cm, preferably of 12.7 cm×8.6 cm×1.5 cm.

According to a further embodiment, the bottom has dimensions of 10 to 15 cm×6 to 10 cm×0.01 to 0.03 cm, preferably of 11.5 cm×7.5 cm×0.015 cm.

According to a further embodiment, the width and the height of the channels (53) lies between 10 and 100 μm, preferably between 30 and 70 μm.

According to a further embodiment, the inlet openings have a diameter of 100 to 500 μm, preferably 220 μm to 270 μm, and the outlet openings have a diameter of 20 μm to 100 μm, preferably 40 μm to 80 μm.

According to a further embodiment, the surface energy of the material of which the bottom consists is less than 35 mN/m, preferably less than 28 mN/m.

According to a further embodiment, the bottom consists of at least two foils of commercially available polyimide for hot pressing.

According to a further embodiment, the thickness of the polyimide foil lies between 25 and 200 μm, preferably between 50 μm and 150 μm.

A further embodiment envisages that the device further comprises a pressure means for impinging upon the bore holes with a pressure.

According to a further embodiment, the pressure means consist of a cap which forms a chamber with the plate over the bore holes and has a pressure hole.

Preferably the cap is provided with a seal on its side facing the plate, which seal surrounds the bore holes and connects the cap to the plate.

According to still another embodiment, the device has at least one sensor on the lower surface of the bottom.

The sensor is preferably a capacitive sensor.

A further preferred embodiment envisages that the sensor consists of two electrodes separated from each other by an insulating layer, one of these electrodes being movable.

The subject matter of the invention is also a method for producing the inventive device in which

a plate, which has a plurality of bore holes, and

a bottom, which has a plurality of channels,

each channel of the bottom having an inlet opening on a side facing the plate and an outlet opening on a side remote from the plate, and

the spacing between the centerline of two adjacent outlet openings being smaller than the spacing between the centerlines of two adjacent inlet openings,

are connected together such that each bore hole of the plate is assigned to a single channel of the bottom.

A further subject matter of the invention is the use of the inventive device for applying a plurality of microdroplets on at least one substrate.

Subject matter of the invention is in addition a method for applying a plurality of microdroplets on a substrate by means of a device according to the invention, with the following steps:

a) filling at least one of the bore holes with at least one fluid,

b) installing the substrate under the bottom until a fluid meniscus emerging from the outlet opening assigned to the filled bore hole touches the substrate and a microdroplet is transferred onto the substrate, and

c) removal of the substrate from the bottom.

Preferably a device with a pressure means is used, and the bore holes are impinged upon with a pressure in the course a step d) provided for between the steps a) and b).

Preferably a device with a cap is used, which cap forms with the plate a pressure chamber over the bore holes, and has a pressure hole so that a pressure can be introduced through the pressure hole.

According to a further embodiment, the value of the relative pressure lies between 0 mbar and 1000 mbar, preferably between 10 mbar and 30 mbar.

According to a further embodiment, the installation and the removal of the substrate is checked by means of a sensor in the steps b) and c).

According to a preferred embodiment, the steps b), c) and if applicable d) are repeated for a plurality of substrates.

According to a preferred embodiment, the steps b), c) and if applicable d) are repeated between 1 and 2 000 000 times, preferably between 1 000 and 10 000 times.

Further features and purposes of the invention result from the description of embodiment examples with reference to the figures. Of the figures:

FIG. 1 shows a diagrammatic cross-sectional view of a device of the state of the art (this figure corresponds to FIG. 5 of WO 01/17669);

FIG. 2 shows a diagrammatic view from above of the device shown in FIG. 1 (this figure corresponds to FIG. 4 of WO 01/17669);

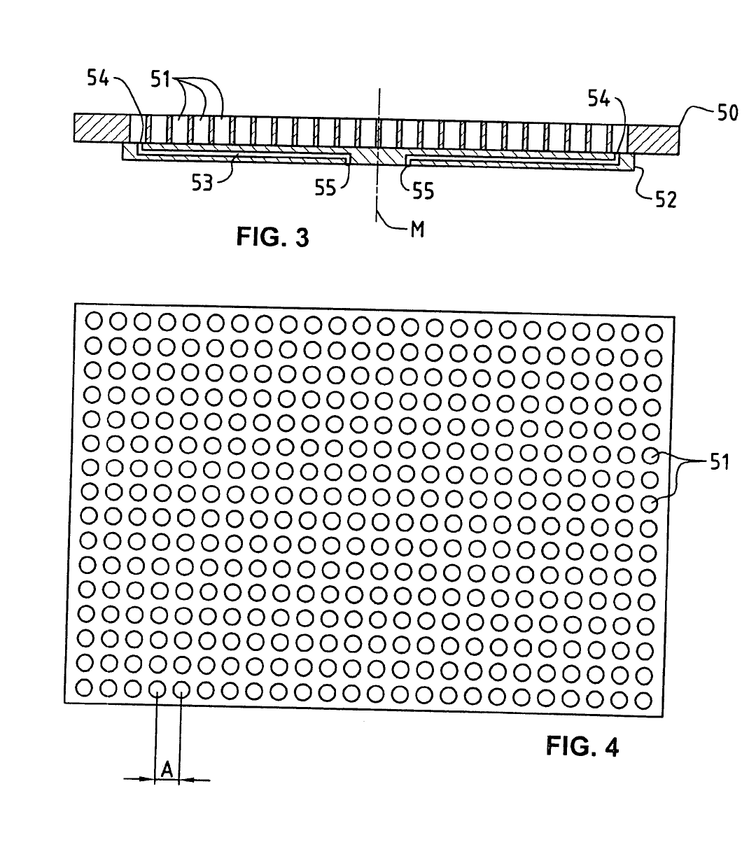

FIG. 3 shows a diagrammatic cross-sectional view of a device according to the invention;

FIG. 4 shows a view from above of a plate of the device according to the invention;

FIG. 5 shows a view from below of a bottom of the device according to the invention;

FIG. 6 shows a view from above of a bottom of the device according to the invention;

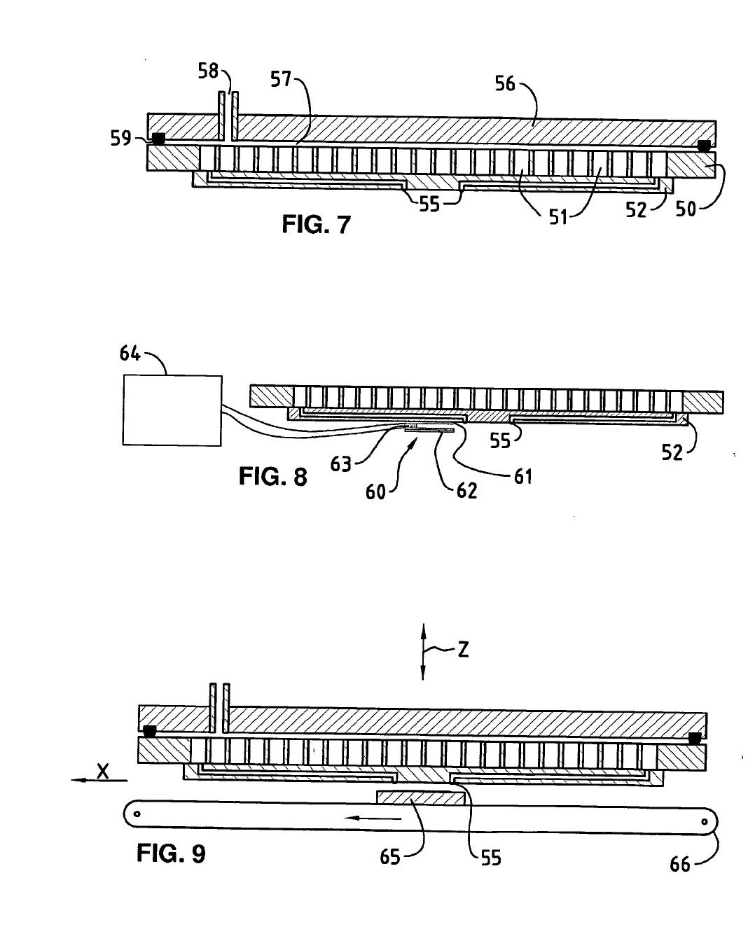

FIG. 7 shows a diagrammatic cross-sectional view of a device according to a further embodiment of the invention;

FIG. 8 shows a diagrammatic cross-sectional view of a device according to a further embodiment of the invention; and

FIG. 9 shows a diagrammatic cross-sectional view of a device according to a further embodiment of the invention.

### EMBODIMENTS OF THE INVENTION

Device According to the Invention

The device according to the invention is shown in FIG. 3 It has a plate 50 having a plurality of bore holes 51, and a bottom 52 which is connected to the plate 50 and has a plurality of channels 53.

Each channel 53 of the bottom 52 has an inlet opening 54 on a side facing the plate 50 and an outlet opening 55 on a side remote from the plate 50.

According to the invention, each bore hole 51 of the plate 50 is assigned to a single channel 53. Such a design has great advantages, viz. that in using the device a mixing of the fluids emerging out of the bore holes 51 is prevented, and in that the bore holes 51 are able to form a simple grid having in general a regular geometry.

All bore holes 51 are preferably substantially identical. Thus the plate 50 can be a standard microplate. Such a microplate can be made of commercially available PS or PP material. It usually forms a pattern of 8×12, 16×24, 32×48, etc. bore holes. Such a standard microplate has standard dimensions of 12.7 cm×8.6 cm×1.5 cm.

The use of a standard microplate makes possible a considerable reduction in the price of the device according to the invention.

The bottom 50 <sic. 52> is generally in the form of a plate, and its length and width must of course be at least large enough that all bore holes 51 can be contained. The bottom 50 <sic. 52> can have dimensions similar to the plate 50.

FIG. 4 shows the upper surface of the plate 50, and FIG. 5 the lower surface of the bottom 52. From a comparison of these two figures with each other, it can be seen that the spacing a between the centerlines of two adjacent outlet openings 55 is smaller than the spacing A between the centerlines of two adjacent inlet openings 54. In this way the channels 53 converge from their inlet openings 54 to their outlet openings 55, and, in comparison with the pattern formed by the bore holes, they are combined into a miniaturized format corresponding to the pattern of the plate 50.

For practical reasons, the converging of the channels 53, or respectively the outlet openings 55, takes place preferably through a regular alignment of the centerline M of the bottom 52. Understood by “centerline M” is the line which is perpendicular to the side that is in contact with the plate 50.

The plate shown in FIG. 4 comprises 16×24 bore holes 51.

FIG. 6 shows a view from above of a bottom 52, which can cooperate with the plate of FIG. 4. It can be seen from this figure how the channels 53 converge from the inlet openings 54 with their outlet openings 55 toward the center or respectively centerline of the bottom.

The thickness of the bottom 52 can be very variable, and a plurality of levels of channels 53 can be present.

The bottom 52 can consist of different materials. For example, the bottom can consist of at least to foils in which the channels 53 and inlet openings 54 are etched and sealed. Then the outlet openings 55 are put in the sealed foil. These channels 53 with their inlet and outlet openings 54, 55 can be produced with usual processes (e.g. dry etching, laser ablation). The sealing takes place through pressing on one another and heating of the foils with a standard heating press.

The channels typically have a width of 10 to 100 μm and a height of 10 to 100 μm. Preferably the width and the height lie between 30 and 70 μm.

The inlet openings 54 can have a diameter of 100 to 500 μm, and are disposed in a grid which reproduces the pattern of the plate.

Preferably the cross-sectional area of the outlet openings 55 is smaller than the cross-sectional area of the inlet openings 54, i.e. a diameter of 20 μm to 100 μm.

All outlet openings 55 are preferably substantially identical so that during use of the device the same amount of each fluid can be applied to the substrate.

Preferably the configuration of the outlet openings 55 of the channels 53 of the bottom 52 corresponds to the configuration of the bore holes 51 of the plate 50. In other words, the first outlet opening 55 in the first outlet opening line corresponds to the first bore hole 51 in the first bore hole line, the second outlet opening in the second outlet opening line corresponds to the second bore hole 51 in the second bore hole line, etc. Such a bottom is then referred to as “structured bottom.”

Concerning the material of the bottom 52, it has been noted that good results can be obtained if the bottom 52 has a slightly moistening surface property.

Preferably the surface energy of the bottom is less than 35 mN/m, in particular less than 28 mN/m.

Preferably the bottom is made up of one or more polyimide foils. When using the device according to the invention a printed substrate of high quality is thus produced. The material polyimide has a low surface energy, which is less than 35 mN/m.

Furthermore polyimide is stable in many solutions, also stable in connection with DMSO (dimethyl sulfoxide), which is very often used.

Moreover polyimide foils are produced in large quantities for the flexprint and electronics industry. This guarantees a low purchase price of the raw material, and thus also a low selling price of the end product (i.e. the device).

Used as polyimide can be the polyimides which are marketed under the trademark designations Upilex of UBE Europe GmbH (DOsseldorf) and Kapton KJ of DuPont.

The thickness of the polyimide foil generally lies between 25 and 200 μm, preferably between 50 μm and 150 μm.

The bottom 50 can also consist of a plurality of foils. The produced channels of a foil are closed through the connection of the foil to another foil. The individual foils are melted together under pressure and simultaneous heating with a standard thermo-compressive hydraulic or mechanical press without melting the channels.

According to a further embodiment of the invention, the device further comprises a pressure means for impinging upon the bore holes 51 with a pressure. The pressure serves to accelerate the circulation of the fluid from the bore holes 51 to the outlet openings 55.

In the embodiment example of FIG. 7, the pressure means consists of a cap 56 which, with the plate 50, forms a chamber 57 over the bore holes 51 and has a pressure hole 58.

Preferably the cap 56 is provided with a seal on its side facing the plate, in order to ensure the leak tightness of the chamber 57. The seal can be a gasket 59 which surrounds all bore holes 51 and connects the cap 56 to the plate.

The cap 56 can be fastened on the plate with changeable clasps (not shown) or it can be screwed on.

FIG. 8 shows a further embodiment of the invention, the device having at least one sensor 60 on the lower surface of the bottom 52.

Preferably the sensor 60 is a capacitive sensor 60, which preferably consists of two electrodes 61, 62 separated from each other by an insulating layer 63, one 62 of these electrodes 61,62 being movable.

Preferably the movable electrode 62 is provided on its upper surface with an insulating layer that insulates it electrically from the substrate during use of the device.

Manufacture of the Device According to the Invention

In manufacture of the device, the plate 50 is connected to the bottom 52. The connection can take place with or without adhesive. Without adhesive, a thermo-compressive process is used as a rule. If a flexible foil is used as the bottom 52, this foil becomes a firm, solid plate through the connection of the bottom 52 to the plate 50.

Use of the Device According to the Invention

The device is preferably used to apply a plurality of microdroplets to a substrate. The plate 50 and the bottom 52 then normally lie horizontal.

For example, if a standard microplate 32×48 is used as the plate 50, then 1536 different fluids can be put in each of the bore holes 51.

The supply of the bore holes 51 can take place by means of standard pipette automats.

Surprisingly with the initial introduction of 50 μl of fluid in each bore hole 51 and a transfer volume of 50 pl, up to 1 000 000 microdroplets can be transferred per fluid. This means that about 1 000 000 substrates can be treated.

Since in general the volume of each bore hole 51 lies between 10 μl and 100 μl, and the volume of each microdroplet between 50 μl and 1 nl, in general 10 000 up to 2 000 000 substrates can be applied.

Inventive Method

The application of a plurality of microdroplets on a substrate by means of the device according to the invention can take place through the following essential steps:

a) filling at least one of the bore holes 51 with at least one fluid, b) installing the substrate 65 under the bottom 52 until a fluid meniscus emerging from the outlet opening assigned to the filled bore hole 51 touches the substrate 65 and a microdroplet is transferred onto the substrate 65, and

c) removal of the substrate 65 from the bottom 52.

All bore holes 51 are generally filled, and each bore hole 51 is filled with a different fluid. A portion of each fluid is transferred onto the substrate in step b). This takes place at the same time for all outlet openings 55.

The fluids can comprise biological substances such as e.g. oligonucleotides, DNA (deoxyribonucleic acid), etc.

The applied substrate has a grid of fluid droplets in high density. The size of the fluid droplets depends upon the respective outlet opening 55. In other words, the grid results from the outlet openings 55.

Preferably the device uses a pressure means, and the bore holes are impinged upon with a pressure in the course of a step d) between steps a) and b).

Preferably a device with a cap 56 is used that forms, with the plate, a chamber 57 over the bore holes 51, and has a pressure hole 58, and a pressure is introduced through the pressure hole.

The pressure can consist of a compressed gas, for example a neutral gas such as nitrogen, helium, or a compressed gas mixture such as compressed air.

This pressure then distributes itself homogeneously over all bore holes 51.

The value of the relative pressure generally lies between 0 mbar and 1000 mbar, preferably between 10 mbar and 30 mbar.

The bore holes 51 serve as reservoir for the different fluids. Through application of the pressure on the bore holes 51, the various fluids are pushed into the channels 53, and flow to the outlet opening 55, where they are stopped by the surface tension.

Preferably a device with a seal is used. The seal (e.g. the gasket 59) also makes possible a sealing off of the plate with respect to the atmospheric pressure.

According to a further embodiment, the installation and the removal of the substrate is checked by means of a sensor in steps b) and c).

The acceleration to the contacting of the substrate, the moving away of the substrate and the holding time can be kept under control. For this purpose simple, commercially available z-axis robotics with steering can be used. Such a control 64 is connected to the sensor 61,62, as can be seen in FIG. 8.

The control can also control the switching on and off of the application of the gas or of the gas mixture.

After the microdroplets have been transferred to the substrate, the latter can be displaced.

Steps b), c) and, if applicable, d) can also be repeated for a plurality of substrates.

Preferably steps b), c) and, if applicable, d) are repeated until the bore holes 51 are empty.

Generally steps b), c) and, if applicable, d) are carried out between 1 and 2 000 000 times, preferably between 1 000 and 10 000 times.

During application of substrates, the pressure can be changed and optimized or completely omitted, depending upon characteristics of the fluid.

Shown in FIG. 9 is the displacement of a substrate 65 in the x-direction (i.e. horizontal) as well as the movement of the device along the arrow z (i.e. vertical). The displacement of the substrate 65 can be accomplished by means of a commercially available conveyor belt 66. Other types of automatic drive are also possible.

The spacing between the outlet openings 55 and the substrate 65 for the fluid transfer can be controlled. This can be accomplished simply through setting of the z-coordinates or through use of the capacitive sensor 61, 62. The electrode 62 then touches the substrate 65. The control electronics measures the capacitance, and checks the spacing between the outlet openings 55 and the substrate 65.

Preferably a plurality of sensors are used, and their average value generates the reference dimension for the spacing.

A further advantage of the invention lies in that developed processes of the flexprint industry can be used after small changes, which keeps production costs low. The invention is produced with mass production methods.

Furthermore the invention is geared to already existing formats and applications, which simplifies the integration in already existing laboratory structures.

1. A device for applying a plurality of microdroplets on a substrate (65), with
a plate (50) having a plurality of bores (51), and
a bottom (52), which is connected to the plate (50) and has a plurality of channels (53),
each channel (53) of the bottom (52) having an inlet opening (54) on a side facing the plate (50) and an outlet opening (55) on a side remote from the plate (50), and
the spacing a between the centerlines of two adjacent outlet openings (55) being smaller than the spacing A between the centerlines of two adjacent inlet openings (54),
wherein each bore hole (51) of the plate (50) is assigned to a single channel (53) of the bottom (52).

2. The device of claim 1, wherein all bore holes (51) are substantially identical.

3. The device according to claim 1 or 2, wherein the configuration of the outlet openings (55) of the channels (53) of the bottom corresponds to the configuration of bore holes of the plate (50).

4. The device according to one of the claims 1 to 3, wherein all outlet openings (55) are substantially identical.

5. The device according to one of the claims 1 to 4, wherein the outlet openings (55) are disposed regularly about the centerline M of the bottom (52).

6. The device according to one of the preceding claims, wherein the cross-sectional area of the outlet openings (55) is smaller than the cross-sectional area of the inlet openings (54).

7. The device according to one of the preceding claims, wherein the plate (50) has dimensions of 10 to 15 cm×6 to 10 cm×0.3 to 3 cm.

8. The device according to claim 7, wherein the plate (50) has dimensions of 12.7 cm×8.6 cm×1.5 cm.

9. The device according to one of the preceding claims, wherein the bottom (52) <has> dimensions of 10 to 15 cm×6 to 10 cm×0.01 to 0.03 cm.

10. The device according to claim 9, wherein the bottom (52) has dimensions of 11.5 cm×7.5 cm×0.015 cm.

11. The device according to one of the preceding claims, wherein the width and the height of the channels (53) lies between 10 and 100 μm.

12. The device <according to> claim 11, wherein the width and the height of the channels (53) lies between 30 and 70 μm.

13. The device according to one of the preceding claims, wherein the inlet openings (54) have a diameter of 100 to 500 μm, and the outlet openings (55) have a diameter of 20 μm to 100 μm.

14. The device according to claim 13, wherein the inlet openings (54) have a diameter of 220 μm to 270 μm, and the outlet openings (55) a diameter of 40 μm to 80 μm.

15. The device according to one of the preceding claims, wherein the surface energy of the material of which the bottom (52) consists is less than 35 mN/m.

16. The device according to claim 15, wherein the surface energy of the material of which the bottom (52) consists is less than 28 mN/m.

17. The device according to one of the preceding claims, wherein the bottom (52) consists of at least two foils of polyimide.

18. The device according to claim 17, wherein the thickness of the polyimide foil lies between 25 and 200 μm.

19. The device according to claim 18, wherein the thickness of the polyimide foil lies between 50 μm and 150 μm.

20. The device according to one of the preceding claims, wherein the device further comprises a pressure means (56, 58) for impinging upon the bore holes (51) with a pressure.

21. The device according to claim 20, wherein the pressure means consists of a cap (56) which, with the plate (50), forms a chamber (57) over the bore holes (51) and has a pressure hole (58).

22. The device according to claim 21, wherein the cap (56) is provided with a seal (59) on its side facing the plate, which seal surrounds the bore holes (51) and connects the cap (56) to the plate (50).

23. The device according to one of the preceding claims, wherein the device has furthermore at least one sensor (61, 62) on the lower surface of the bottom (52).

24. The device according to claim 23, wherein the sensor is a capacitive sensor (61, 62).

25. The device according to claim 24, wherein the sensor (61,62) consists of two electrodes (61, 62) separated from each other by an insulating layer, one (62) of these electrodes (61,62) being movable.

26. A method for producing a device for applying a plurality of microdroplets on a substrate (65) in which
a plate (50), which has a plurality of bore holes (51), and
a bottom (52), which has a plurality of channels (53),
each channel (53) of the bottom (52) having an inlet opening (54) on a side facing the plate (50) and an outlet opening (55) on a side remote from the plate (50), and
the spacing a between the centerline of two adjacent outlet openings (55) being smaller than the spacing A between the centerlines of two adjacent inlet openings (54),
are connected together such that each bore hole (51) of the plate (50) is assigned to a single channel (53).

27. The use of a device according to one of the claims 1 to 25 for applying a plurality of microdroplets on at least one substrate (65).

28. A method for applying a plurality of microdroplets on a substrate (65) by means of a device according to one of the claims 1 to 25, with the following steps:
a) filling at least one of the bore holes (51) with at least one fluid,
b) installing the substrate (65) under the bottom (52) until a fluid meniscus emerging from the outlet opening assigned to the filled bore hole (51) touches the substrate (65) and a microdroplet is transferred onto the substrate (65), and
c) removal of the substrate (65) from the bottom (52).

29. The method according to claim 28, a device according to one of the claims 20 to 25 being used, and the bore holes (51) being impinged upon with a pressure between the steps a) and b).

30. The method according to claim 29, a device according to claim 21 being used, with the following additional step: d) introduction of the pressure through the pressure hole (58).

31. The method according to claim 30, the value of the relative pressure lying between 0 mbar and 1000 mbar.

32. The method according to claim 31, the value of the relative pressure lying between 10 mbar and 30 mbar.

33. The method according to one of the claims 28 to 32, a device according to one of the claims 23 to 25 being used, in steps b) and c) the installation and the removal of the substrate (65) being checked by means of the sensor (61,62).

34. The method according to one of the claims 28 to 33, wherein the steps b), c) and if applicable d) being repeated for a plurality of substrates (65).

35. The method according to claim 34, wherein the steps b), c) and if applicable d) being repeated being repeated between 1 and 2 000 000 times.

36. The method according to claim 35, wherein the steps b), c) and if applicable d) being repeated between 1 000 and 10 000 times.
